(19) United States
(12) Patent Application Publication
(10) Pub. No.: US 2017/0141616 A1
(43) Pub. Date: May 18, 2017

(54) Contactless Connector System Having Feedback From Secondary Side

(71) Applicants: TE Connectivity Nederland BV, AR s'Hertogenbosch (NL); TE Connectivity Germany GmbH, Bensheim (DE)

(72) Inventors: Gied Habraken, Valkenswaard (NL); Jeroen Dittner, Rosmalen (NL); Benjamin Mang, Mannheim (DE); Reza Hossaini, Muhlheim am Main (DE); Samir Aboulkassem, Darmstadt (DE); Felix Lange, Frankfurt am Main (DE)

(73) Assignees: TE Connectivity Nederland BV, AR s'Hertogenbosch (NL); TE Connectivity Germany GmbH, Bensheim (DE)

(21) Appl. No.: 15/349,415

(22) Filed: Nov. 11, 2016

(30) Foreign Application Priority Data
Nov. 13, 2015 (EP) 15194497.2

(51) Int. Cl. H02J 50/12; H02J 50/80

(52) U.S. Cl. CPC H02J 50/12; H02J 50/80

(57) ABSTRACT

A contactless connector system is disclosed. The contactless connector system has a power transmitting connector and a power receiving connector. The power transmitting connector has a primary resonant circuit generating a magnetic field at a primary inductive coupler, a primary data transceiver, and a primary control unit connected to and controlling the resonant circuit and the primary data transceiver. The power receiving connector has a secondary inductive coupler electromagnetically coupled to the primary inductive coupler and receiving electric power from the primary inductive coupler, a secondary data transceiver connected with the primary data transceiver to form a bi-directional data link with the primary data transceiver, and a secondary sensing unit measuring at least one secondary operational parameter. The primary control unit controls the resonant circuit based on the at least one secondary operational parameter.

### CROSS-REFERENCE TO RELATED APPLICATION

This application claims the benefit of the filing date under 35 U.S.C. §119(a)-(d) of European Patent Application No. 15194497.2, filed on Nov. 13, 2015.

### FIELD OF THE INVENTION

The present invention relates to a contactless connector system, and more particularly, to a contactless connector system for inductively transmitting power.

### BACKGROUND

Inductive energy transfer in a contactless connector is known in which an inductor or a magnetic winding in a primary side power transmission device is magnetically coupled with an inductor or a magnetic winding in a secondary target device. Energy is inductively transferred between the primary side and the secondary of the contactless connector; if the secondary is removed from the primary side, the energy transfer is interrupted. In this context, the term “contactless” is used to indicate that energy transfer can be realized without any ohmic connection between corresponding electrical contacts on the primary side and secondary, respectively.

Omission of electrical contacts is of great importance for many applications, such as in applications involving electric connections between a power source and sink in which technically complex plugs and cables can be avoided by application of inductive energy transfer (“IE”). Further, technical energy supply system components based on IE can be protected from environmental impacts without using mechanically complex connectors. Moreover, in some application areas for IE, the use of electrical connections has to be avoided in light of technical feasibility. Furthermore, the use of IE can improve the reliability of systems in which the devices and contacts are exposed to high stress, such as systems with rotating or moveable parts prone to wear due to friction.

A contactless connector system is disclosed in European patent specification EP 2581994 B1. The contactless connector system has primary side and secondary inductive couplers that can be mated for wirelessly transmitting electric power from the primary to the secondary. A bi-directional data transmission is also established between two antennas, thereby establishing a radio frequency data link between the two parts of the connector system.

Another known contactless connector system is shown in FIG. 1. This contactless connector system 200 comprises a power transmitting connector 202 and a power receiving connector 204. The power transmitting connector 202 has a primary inductive coupler Lp which is powered from an input power source. The input power may for instance be a DC power which is transformed into an alternating voltage by means of a DC/DC converter 206 and a subsequent DC/AC converter 208. As this is schematically shown in FIG. 1, the inductive coupler Lp is part of a resonant circuit 210 which comprises a capacitor Cp in parallel to the inductive coupler Lp.

When the two mating surfaces 212, 214 of the power transmitting connector 202 and the power receiving connector 204 are sufficiently close, the secondary inductive coupler Ls is magnetically coupled to the primary inductive coupler Lp. The secondary inductive coupler Ls is part of a secondary resonant circuit 216. By means of the electromagnetic coupling, power is transmitted from the primary side to the secondary. The secondary resonant circuit 216 is connected to a rectifier circuit 218 (comprising for instance a bridge rectifier) and a subsequent DC/DC converter 224 generating a regulated DC output power.

In addition to the power transmission, the contactless connector system 200 is further equipped with means for establishing a bi-directional data link for transmitting data through the connector system 200. A primary side data communication interface 222 communicates with a first external component connected to the power transmitting connector 202. A primary side data transceiver 224 having one or more antennas 226 converts the data signals from the communication interface 222 into radio signals and accordingly converts received radio signals into electrical data signals which are input into the communication interface 222.

The power receiving connector 204 is provided with a corresponding secondary data transceiver 228 having one or more antennae 230 which receive signals from the primary side and transmit signals from the secondary towards the primary side via a wireless near field radio link. A secondary data communication interface 232 is connected to the secondary data transceiver 228 for communicating with a second external component connected to the power receiving connector 204.

A primary control unit 234 controls the operation of the resonant circuit 210, the primary side data communication interface 222, and the primary side data transceiver 224.

Known contactless connector systems which transmit both power and data use resonant driving circuitry to transmit the power in an efficient way and control these resonant systems based on a feed forward control; no information measured and transmitted from the secondary is available for the control. This is particular common for contactless connector systems that have to meet strict requirements regarding their overall size.

### SUMMARY

An object of the invention, among others, is to provide a contactless connector system that transmits both power and data in a particularly energy efficient, safe, and robust manner. The disclosed contactless connector system has a power transmitting connector and a power receiving connector. The power transmitting connector has a primary resonant circuit generating a magnetic field at a primary inductive coupler, a primary data transceiver, and a primary control unit connected to and controlling the resonant circuit and the primary data transceiver. The power receiving connector has a secondary inductive coupler electromagnetically coupled to the primary inductive coupler and receiving electric power from the primary inductive coupler, a secondary data transceiver connected with the primary data transceiver to form a bi-directional data link with the primary data transceiver, and a secondary sensing unit measuring at least one secondary operational parameter. The primary control unit controls the resonant circuit based on the at least one secondary operational parameter.

### BRIEF DESCRIPTION OF THE DRAWINGS

The invention will now be described by way of example with reference to the accompanying figures, of which:

FIG. 1 is a block diagram of a contactless connector system known in the art;

FIG. 2 is a perspective view of a contactless connector system according to the invention;

FIG. 3 is a block diagram of the contactless connector system of FIG. 2;

FIG. 4 is a schematic of a transmitting part of a transceiver unit of the contactless connector system;

FIG. 5 is a schematic of a receiving part of a transceiver unit of the contactless connector system;

FIG. 6 is a schematic of time division multiplexing for transmitting in the contactless connector system;

FIG. 7 is a schematic of time division multiplexing for receiving in the contactless connector system;

FIG. 8 is a schematic of channel separation in the contactless connector system;

FIG. 9 is a circuit diagram of resonant circuits according to an embodiment of the contactless connector system;

FIG. 10 is a circuit diagram of resonant circuits according to an embodiment of the contactless connector system;

FIG. 11 is a circuit diagram of resonant circuits according to an embodiment of the contactless connector system;

FIG. 12 is a circuit diagram of resonant circuits according to an embodiment of the contactless connector system;

FIG. 13 is a circuit diagram of resonant circuits according to an embodiment of the contactless connector system; and

FIG. 14 is a circuit diagram of a power transmission circuit of the contactless connector system.

### DETAILED DESCRIPTION OF THE EMBODIMENT(S)

The specific embodiments of the present invention will be described hereinafter in detail, and examples thereof are illustrated in the attached drawings, in which like reference numerals refer to like elements. The specific embodiments described with reference to the attached drawings are only exemplary, so as to fully convey the scope of the invention to those skilled in the art, and should not be construed as limiting the present invention.

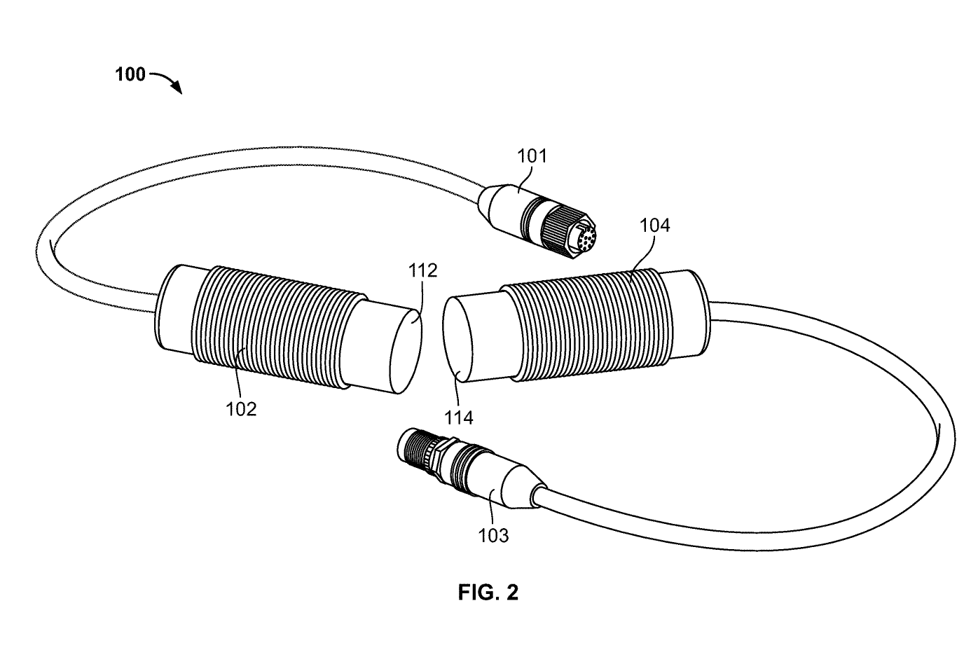

A contactless connector system 100 according to the invention is shown in FIG. 2. The contactless connector system 100 has a power transmitting connector 102 which can be connected to a power source via a first terminal 101. The power transmitting connector 102 defines a primary side of the contactless connector system 100. The contactless connector system 100 further comprises a power receiving connector 104 which defines a secondary of the contactless connector system 100. A second terminal 103 is provided for connecting the system to a secondary external component.

The power transmitting connector 102 has a transmitting mating surface 112 and the power receiving connector 104 has a receiving mating surface 114. When the transmitting mating surface 112 and the receiving mating surface 114 are brought sufficiently close to each other, the power receiving connector 104 is electromagnetically coupled with the power transmitting connector 102 so that a contactless inductive energy transfer from the primary side to the secondary can take place. In addition to allowing the inductive power transfer, the contactless connector system 100 is also able to provide a bi-directional data link between the two connectors 102, 104.

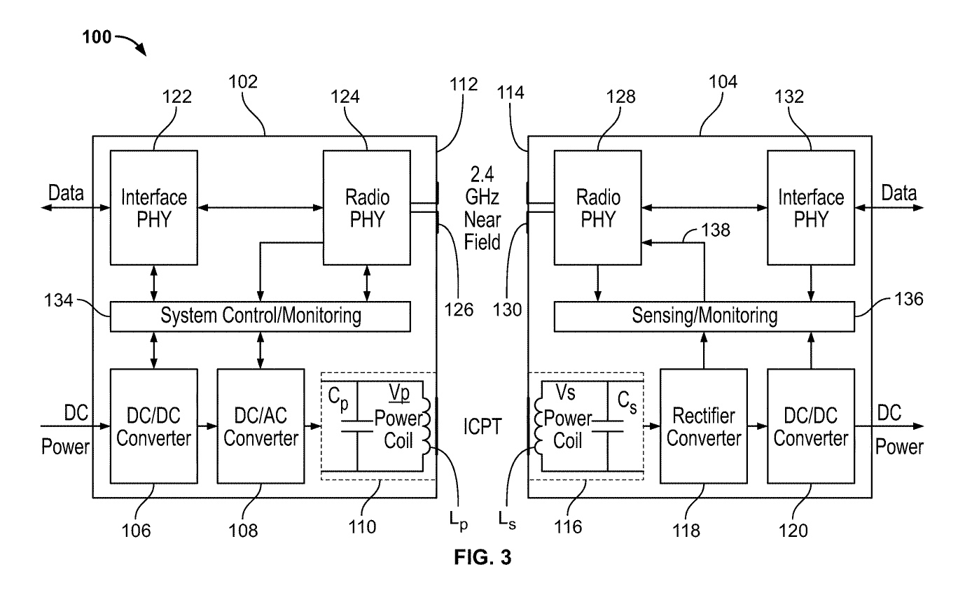

FIG. 3 is a block diagram of the power transmitting connector 102 and the power receiving connector 104. The power transmitting connector 102 has a primary inductive coupler Lp (also referred to as primary side power coil) which is powered from an input power source. The input power may for instance be a DC power which is transformed into an alternating voltage by means of a DC/DC converter 106 and a subsequent DC/AC converter 108. The inductive coupler Lp is part of a primary resonant circuit 110 which comprises a capacitor Cp in parallel to the inductive coupler Lp. The primary resonant circuit 110, however, may also be a serial resonant circuit.

When the two mating surfaces 112, 114 of the power transmitting connector 102 and the power receiving connector 104 are sufficiently close to each other, a secondary inductive coupler Ls is magnetically coupled to the primary inductive coupler Lp. The secondary inductive coupler Ls is part of a secondary resonant circuit 116. By means of the electromagnetic coupling, power is transmitted from the primary side to the secondary side. The secondary resonant circuit 116 is connected to a rectifier circuit 118 (comprising for instance a bridge rectifier) and a subsequent DC/DC converter 120 generating a regulated DC output power.

The contactless connector system 100 is further equipped with means for establishing a bi-directional data link for transmitting data through the connector system 100. A primary data communication interface 122 communicates with a first external component connected to the power transmitting connector 102. A primary data transceiver 124 having one or more antennas 126 converts the data signals from the communication interface 122 into a radio signals and accordingly converts received radio signals into electrical data signals which are input into the communication interface 122. The power receiving connector 104 has a corresponding secondary data transceiver 128 having one or more antennas 130 which receive signals from the primary side and transmit signals from the secondary towards the primary side via a wireless near field radio link. A secondary data communication interface 132 is connected to the secondary data transceiver 128 for communicating with a second external component connected to the power receiving connector 104. The antenna 126 of the primary data transceiver 124 and the antenna 130 of the secondary data transceiver 128 may be circularly polarized antennae that are rotationally symmetrical. Further, one with ordinary skill in the art would find it obvious that an infrared or optical data transmission could be used instead of a near field radio link.

A primary control unit 134 controls the operation of the primary resonant circuit 110, the primary data communication interface 122, and the primary data transceiver 124. The power receiving connector 104 further comprises a secondary sensing unit 136. The secondary sensing unit 136 measures at least one secondary operational parameter and generates control data 138 based on the at least one secondary operational parameter which is transmitted to the primary side to be evaluated by the primary control unit 134. In other words, the data link between the power transmitting connector 102 and the power receiving connector 104 carries in addition to the payload data communicated between the two components which are interconnected by the contactless connector system additional control data which provides information about secondary parameters to the primary control unit 134. This information improves overall performance of the contact connector system 100. The primary control unit 134 may also comprise means for measuring one or more primary operational parameters on the primary side.

The following parameters can be monitored and controlled according to the present invention.

On the transmitter side, the following transmitter parameters can be measured:
a. The input voltage and input current, and as a result, the input power is known
b. The temperature of the power transmitting connector 102
c. The input voltage for the DC/AC converter 108
d. The voltage Vp across the primary inductive coupler Lp, the current through the primary inductive coupler Lp, and the phase between the voltage Vp across the primary inductive coupler Lp and the current through the primary inductive coupler Lp, and as a result, the transmitted power is known
e. Presence of data on the primary data communication interface 122, i.e. whether data is transmitted or not

On the receiver side the following receiver parameters can be measured:
a. The output voltage and output current, and as a result, the output power is known.
b. The temperature of the power receiving connector 104
c. The voltage Vs across the secondary inductive coupler Ls, the current through the secondary inductive coupler Ls, and the phase between the voltage Vs across the secondary inductive coupler Ls and the current through the secondary inductive coupler Ls, and as a result, the received power is known
d. Presence of data on the secondary data communication interface 132, i.e. whether data is transmitted or not

Having the information about the voltages Vp and Vs at the system control 134 on the primary side allows the system control 134 to determine the distance between the power transmitting connector 102 and the power receiving connector 104. Knowing the distance enables functionalities such as a reliable power-over-distance de-rating. By providing the feedback from the power receiving connector 104 described above, the following system features and characteristics of the contactless connector system 100 can be provided:

1. Under Voltage Lockout (hysteresis):

By monitoring the input voltage at the power transmitting connector 102 an improved under voltage lockout mechanism including reliable hysteresis can be implemented.

2. Inrush Current Limiting:

The power receiving connector 104 can be put into standby as long as the power transmitting connector 102 is still starting up. This will reduce an inrush current at the receiver side. Once the power transmitting connector 102 is fully operational, the power receiving connector 104 can be put into normal operation.

3. Soft Start:

As a resulting feature from the limitation of the inrush current, a soft start function can further be implemented.

4. Power Output Short Circuit Protection (constant current/current fold-back):

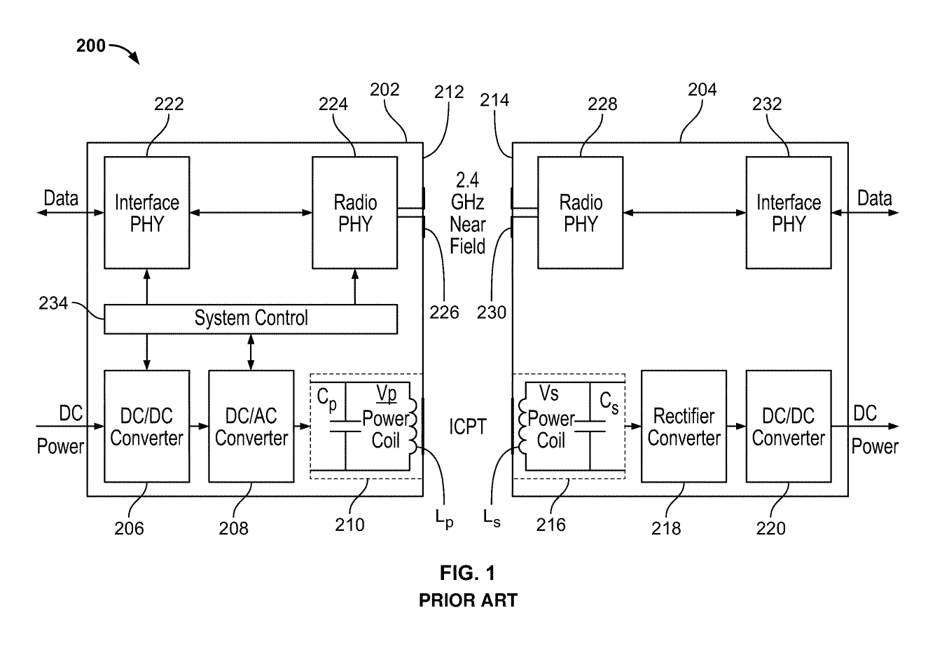

For the conventional connector system 200 explained with reference to FIG. 1, there exists the disadvantage that the system control 234 continuously tries to activate the power output if there is a short circuit at the output of the power transmitting connector 202. By monitoring the output voltage and current, this continuous switch-on/switch-off behavior can be avoided if necessary.

5. Power Operational Readiness:

By receiving the information about the power level on the side of the power receiving connector 104 it is possible to send a feedback signal when operational readiness is reached.

6. Out-of-Power Range:

If the distance between the power transmitting connector 102 and the power receiving connector 104 is known, a minimum power-level with a fixed distance can be defined where a working system can be guaranteed (so called power-over-distance de-rating). If the distance (or the load) becomes too high, the contactless connector system 100 can be switched off in a reliable way.

7. Over Temperature Protection (hysteresis):

The temperature of the contactless connector system 100 is based on two factors: the ambient temperature and the temperature rise inside the device. Currently, only the temperature at the transmitter side is monitored leaving the possibility for the receiver to get overheated. Monitoring the temperature at the receiver side allows for control of (over-)heating on both sides and, in case of a critical temperature, the system can be powered off. Furthermore, measuring the temperature at start-up and after some time the internal temperature rise can be determined and a kind of power-over-temperature can be implemented.

8. Foreign Object Protection:

Currently, a fail-safe foreign object protection is not possible since the power output at the receiver side is unknown. The system shuts down when too much power is drawn from the input, but, since the power is delivered at the output, quite some power can still be generated in metal items between the transmitter and receiver side. By knowing the power levels on both transmitter and receiver side, a far better understanding where the power is sent to will be available, and therefore, the foreign object protection functionality can be improved substantially.

9. Data Reverse Polarity Protection:

By providing a feedback information about whether data is present upon the input line or not, the system is also allowed to consider a power switch off in case a reversed polarity failure is given.

10. Data Output Short Circuit Protection:

A system shut down and accordingly a system protection is granted upon feedback of a short circuit on the data interfaces.

11. Data Operational Readiness:

Readiness is achieved at a defined minimum power-level. This power level is reached when the power is high enough to support the RF-chip for the lowest bit rate that can be applied. It is also possible, with additional distance information, to ensure power-levels and bitrates according to defined fixed distances.

12. Diagnostics:

Additional information and a comparable overview of operational parameters on the primary side and the secondary support any post-analysis and accordingly diagnose malfunctions and allow for real-time system control. Furthermore, an operator can be informed about the status of the system 100 and possible failures like short circuits, over temperatures, etc.

13. Programmability:

With an additional control instance in between the power and the RF portion of each counterpart of the system, it possible to enable programmability for the firmware. The maximum power or data rate for example can be controlled via software.

14. External Wake-up:

The power receiving connector 104 can be put to standby until a wake-up is received, either from the transmitter side or from its data communication interface 132.

In order to feed back the control data 138 along with other payload data that are transmitted over the bi-directional wireless data link, the present invention provides several techniques of introducing the control data 138 into the payload data stream transmitted by the secondary data transceiver 128. It is important that the control data 138 are merged with the payload data to be sent to the power transmitting connector 102 in a way that the payload data stream is not affected by this merging process.

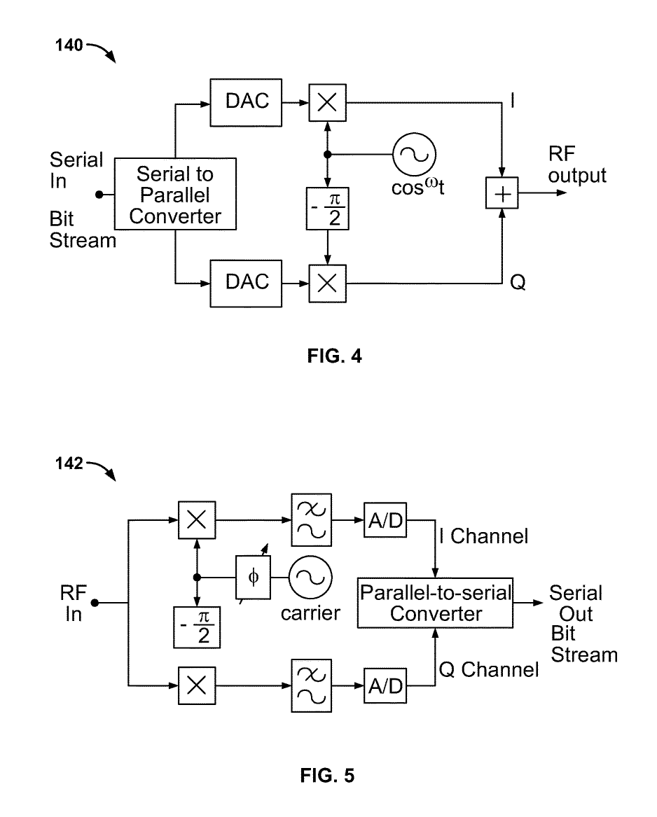

For generating the radiofrequency (RF) signal that is transmitted by means of the antenna 130, the data to be transmitted are modulated onto a carrier signal as is known in the art. Although many radiofrequency modulation schemes are known, in the following only the quadrature amplitude modulation (“QAM”) technique will be explained in more detail and with reference to FIGS. 4 and 5. The secondary transceiver 128 comprises a modulation unit 140, as shown in FIG. 4, generating an RF output signal from a serial bit stream. Correspondingly, the primary side transceiver 124 comprises a demodulation unit 142 shown in FIG. 5.

Like all modulation schemes, QAM conveys data by changing some aspect of a carrier signal or the carrier wave (usually a sinusoid) in response to a data signal. In the case of QAM, the amplitude of two waves, 90° out-of-phase with each other, are modulated or keyed by the modulation unit 140 to represent the data signal. For demodulating the transmitted signal, these two modulated signals can be demodulated by the demodulation unit 142 using a coherent demodulator. As shown in FIG. 5, the demodulation unit 142 multiplies the received signal separately with both a cosine and sine signal to produce the received estimates of I(t) and Q(t), respectively. Because of the orthogonality property of the carrier signals, it is possible to detect the modulating signals independently.

For merging the control signal and the payload signal according to the present invention, any suitable technique of transferring two different channels in an RF system can be employed, such as:
a. Separation in the time domain, i.e. Time Division Multiplexing
b. Separation in the frequency domain, i.e. Frequency Division Multiplexing
c. Separation in the spatial domain
d. Separation using different polarization

The different options of how to merge the low bit-rate control channel with the high bit-rate data channel and transferring all the information to the other side with as minimal influence of the data channel is shown in following examples for the case where a QAM based RF transmission system is used.

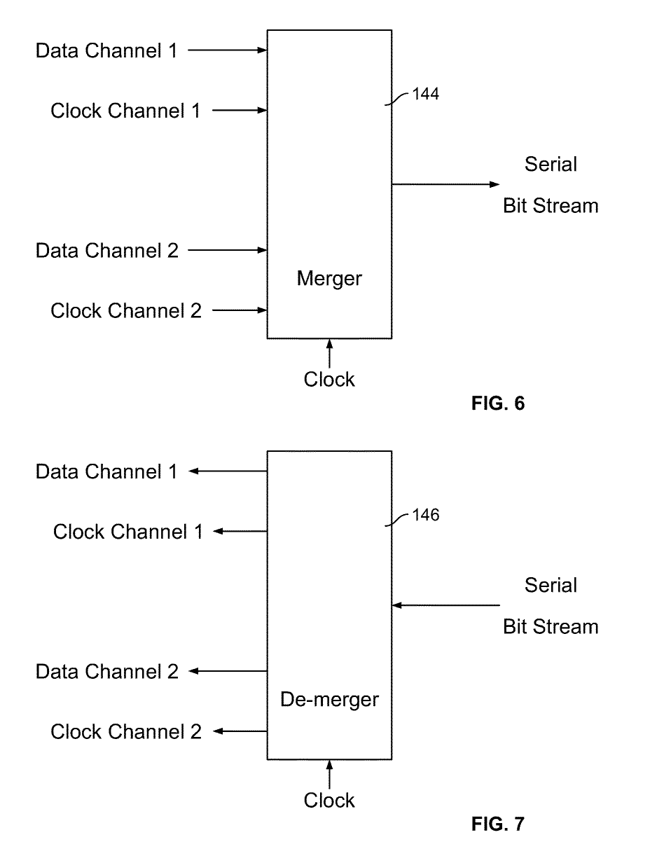

When using separation in the time domain, when a 60 GHz band is used to transfer a 1 Gbps data channel, less than the full availability of the band is used for the payload data transfer. As a result, some bandwidth is still available for the control channel. Merging the payload channel 1 and the control channel 2 shown in FIG. 6 can be done via an increase of the bit rate. Subsequently, the two channels are input into a merger 144 for generating the serial bit stream that is fed into the modulation unit 140 of FIG. 4. On the receiving side in the power transmitting connector 102, the serial bit stream output by the demodulation unit 142 of FIG. 5 is separated into two channels using a de-merger 146 shown in FIG. 7.

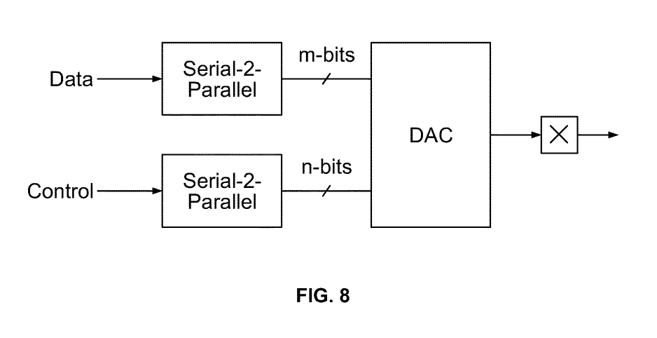

For using a separation in the frequency domain, two different options are available. First, as can be seen from FIG. 4, the input data stream is split into two data streams to create the QAM like modulation. Instead of splitting the data stream, the data channel can be connected to one input (I-channel) while the control channel can be connected to the other input (Q-channel). At the receiving side in the power transmitting connector 102, the parallel-to-serial converter shown in FIG. 5 can be omitted and the data stream is present on the I-channel output and the control stream is present on the Q-channel output. Alternatively, as shown in FIG. 8, instead of separating the I- and Q- channels, the two data streams can be merged by using the different bit inputs of the digital-to-analog converters (“DAC”) shown in FIG. 4.

A spatial separation of the control data from the payload data can also be performed. In this case, two complete RF systems are implemented, one for the data stream and one for the control stream. Also the antennae 226, 230 are separated from each other, so that each of the power transmitting connector 102 and the power receiving connector 104 have separate antennae for transmitting/receiving the control data and the payload data.

Another possibility of separating the control data from the payload data is using a separation by means of the polarization. In this case, also two complete RF systems are implemented, but instead of using two antennae 226, 230, only one antenna 226, 230 is used at each of the power transmitting connector 102 and the power receiving connector 104. One signal is then transmitted with horizontal polarization or right handed polarization while the second signal is transmitted via vertical polarization or left handed polarization.

The above described merging schemes regarding merging control data and payload data from the power receiver 104 towards the power transmitter 102 is also applicable for sending a clock signal over the data stream. In this case, a clock and data recovery (“CDR”) can be omitted.

As described above, the control data that are fed back from the power receiving connector 104 to the power transmitting connector 102 according to the present invention may contain a plurality of parameters to be monitored. An important parameter to be monitored is the distance between the power transmitting connector 102 and the power receiving connector 104. The present invention uses the control data 138 feedback for determining this distance.

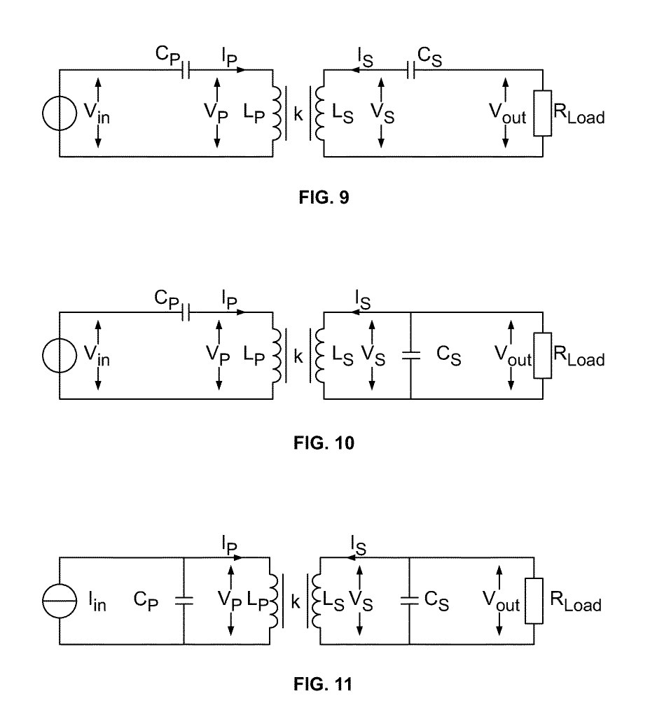

The inductive resonant coupling between the power transmitting connector 102 and the power receiving connector 104 can be achieved by using different resonant circuits 110, 116. In particular, either a parallel resonant circuit or a serial resonant circuit can be used on each side. The primary resonant circuit 110, 116 configurations are shown in FIGS. 9 to 11.

As shown in FIG. 9, a serial arrangement of the primary capacitor Cp and the secondary capacitor Cs with the respective inductively coupled coils can be used, resulting in a serial resonance on the primary and on the secondary. Alternatively, as shown in FIG. 10, a parallel resonance can be provided on the secondary, whereas the primary resonant circuit is a serial arrangement. For the circuits shown in FIGS. 9 and 10, the input is voltage driven by an input Vin. Alternatively, as shown in FIG. 11, a parallel resonant configuration can also be provided on the primary side. In this case, the input has to be current driven by a current source Iin.

For an inductively coupled power transfer system as shown in FIG. 9, the voltages over the transmitter and receiver coils are given by the following equations (1) and (2).

Vₚ=jω·Lₚ·Iₚ+jω·L_{M}·Iₛ (Eqn. 1)

Vₛ=jω·L_{M}·Iₚ+jω·Lₛ·Iₛ (Eqn. 2)

Here Vp is the voltage across the primary side transmitter coil, Vs the voltage across the secondary receiver coil, Ip the current through the primary side transmitter coil, and Is the current through the secondary receiver coil. Lp is the inductance of the primary side transmitter coil, Ls the inductance of the secondary receiver coil, and Lm is the mutual inductance between them.

This mutual inductance can be expressed as a function of the inductances Lp and Ls according to equation (3).

L_{M}=κ·\sqrt{Lₚ·Lₛ} (Eqn. 3)

In equation (3) κ is the coupling coefficient and depends on the distance between the primary side transmitter coil and the secondary receiver coil. As an approximation, the product of the coupling coefficient and the distance between transmitter and receiver coil is constant. Thus, without a load connected to the primary side transmitter coil and the secondary receiver coil (Is=0), the secondary voltage Vs is a measure for the coupling coefficient and therefore also for the distance. Vs can be expressed by equation (4) for the case that Is=0.

Vₛ=jω·L_{M}·Iₚ=jω·κ·\sqrt{Lₚ·Lₛ}·Iₚ (Eqn. 4)

Since the parameters Lp and Ls are known by design and Ip and Vs can be measured, the coupling factor, and thus the distance, can be calculated using equation (4).

There will, however, always be a load on the secondary 104 which influences the distance calculation. The present invention therefore provides two different ways to overcome this issue.

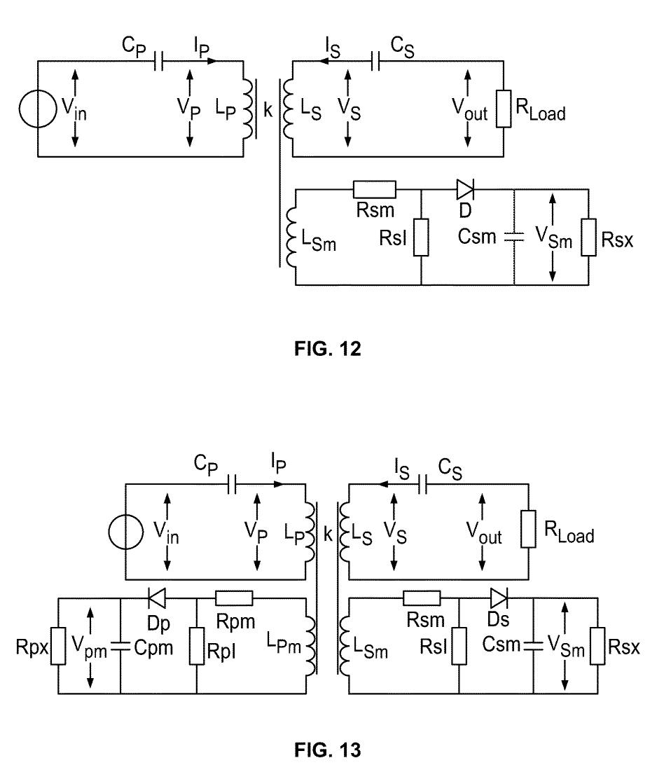

First, the load can be disconnected temporarily, for example, by switching off the rectifier 118 shown in FIG. 3. If this is done for a very short period (e. g. less than 1% of the time), the influence on the power transfer is limited. The drawback of this solution is the need for extra control for switching off the load for short time periods, and the need for fast measurement of the voltage across the secondary receiver coil. Consequently, according to an embodiment of the invention, an extra winding is added to the secondary receiver coil which is not loaded, as shown in FIG. 12. As shown in FIG. 12, the power receiving connector 104 comprises a secondary auxiliary winding Lsm which is inductively coupled to the primary side, but is not connected to the output of the secondary receiver coil and is therefore practically unloaded. The coupling between the secondary auxiliary winding Lsm and the secondary power receiving winding Ls should be close to 1. It can be shown that the ratio Vsm/Ip of the voltage Vsm across the secondary auxiliary winding and the current Ip flowing through the primary side coil is an accurate measure for the coupling factor and thus the distance.

For determining the distance between the power transmitting connector 102 and the power receiving connector 104, the voltage Vsm across the secondary auxiliary winding Lsm is measured. Moreover, the current Ip flowing through the primary side coil has to be determined in order to calculate the distance. At the primary side, the voltage and current can be measured correctly, independent from the secondary load. Therefore, for the functioning of the measurement, no separate primary auxiliary winding is needed. Measuring the current Ip at the primary side power transmitting connector 102, however, can be difficult, and consequently, an additional primary auxiliary winding can be provided as shown in FIG. 13.

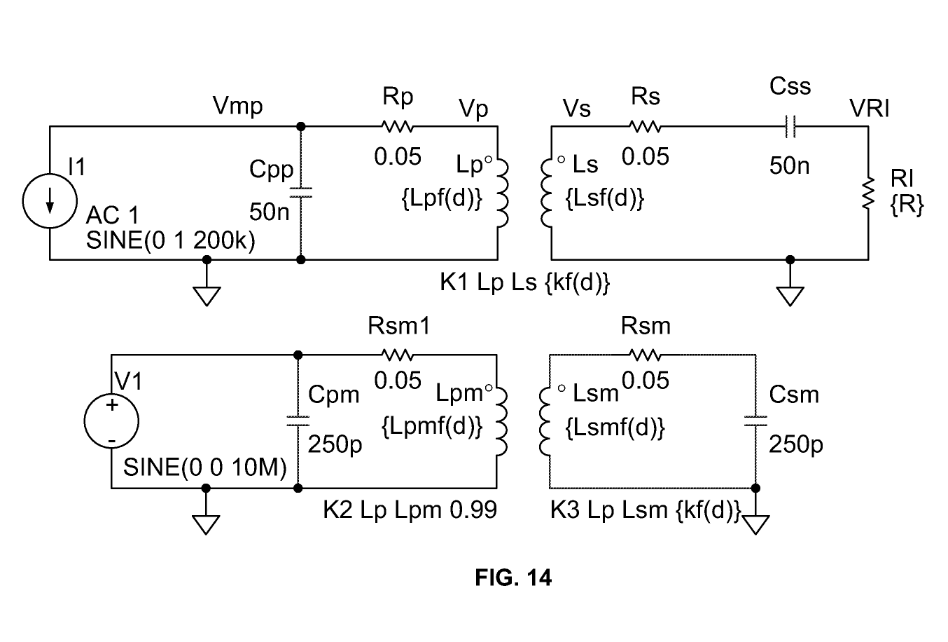

In addition to the measurement of the distance between the power transmitting connector 102 and the power receiving connector 104, a configuration using an auxiliary winding on the primary side and on the secondary can also be used for allowing a foreign object detection (“FOD”). FIG. 14 shows an example of a circuit arrangement that can be used to detect whether a ferromagnetic foreign object has entered between the mating surfaces 112, 114 of the power transmitting connector 102 and the power receiving connector 104. As shown in FIG. 14, foreign object detection can be improved by providing auxiliary windings Lpm and Lsm. According to this embodiment, both auxiliary windings are not loaded and not connected to the power coils Lp, Ls. An additional high frequency signal V1 with low amplitude is provided for driving the primary side auxiliary resonant circuit. The components Lsm, Rsm, Csm of the resonant circuit on the secondary are chosen so that in the absence of any foreign object a resonance occurs on the secondary as well. If the coils at both transmitting and receiving side are tuned to the same frequency the so created resonance will be disturbed easily by any foreign object that “absorbs” magnetic fields. This disturbance can be measured via the detuning of the resonance. This method thereby improves the detection of foreign objects. In case that the same auxiliary windings are used for this foreign object detection and for the distance measurement explained above referring to FIG. 13, it has to be ensured that no interference between the distance measurement and the foreign object measurement occurs. To this end, for example, the resonance frequency V1 can be chosen to be significantly higher than the frequency used for the power transfer, which usually lies around 200 kHz.

Advantageously, in the contactless connector system 100 according to the invention, power and data can be reliably transferred in adverse environments, reducing maintenance costs. Furthermore, by sensing one or more parameters on the secondary 104 and transmitting the information via the bi-directional data link to the primary side 102, a wide variety of parameters can be monitored on the secondary as well as on the primary side, and the information can be used by the primary control unit 134 for optimally controlling the power transfer.

What is claimed is:

1. A contactless connector system, comprising:
a power transmitting connector having a primary resonant circuit generating a magnetic field at a primary inductive coupler, a primary data transceiver, and a primary control unit connected to and controlling the resonant circuit and the primary data transceiver; and
a power receiving connector having a secondary inductive coupler electromagnetically coupled to the primary inductive coupler and receiving electric power from the primary inductive coupler, a secondary data transceiver connected with the primary data transceiver to form a bi-directional data link with the primary data transceiver, and a secondary sensing unit measuring at least one secondary operational parameter, the primary control unit controlling the primary resonant circuit based on the at least one secondary operational parameter.

2. The contactless connector system of claim 1, wherein the primary inductive coupler is connected to a first terminal.

3. The contactless connector system of claim 1, wherein the power transmitting connector has a primary data communication interface connected to the primary data transceiver and communicating with a first external component.

4. The contactless connector system of claim 3, wherein the primary control unit is connected to the primary data communication interface and controls the primary resonant circuit based further on at least one primary operational parameter.

5. The contactless connector system of claim 4, wherein the at least one primary operational parameter is a primary voltage across the primary inductive coupler, the at least one secondary operational parameter is a secondary voltage across the secondary inductive coupler, and the primary control unit determines a distance or a power loss between the primary inductive coupler and the secondary inductive coupler based on the primary voltage and the secondary voltage.

6. The contactless connector system of claim 1, wherein the power receiving connector has a secondary data communication interface connected to the secondary data transceiver and communicating with a second external component.

7. The contactless connector system of claim 6, wherein the secondary data transceiver has a modulation unit merging a control signal generated by the secondary sensing unit with a data output from the secondary data communication interface.

8. The contactless connector system of claim 7, wherein the primary data transceiver has a demodulation unit demodulating the control signal and the data output.

9. The contactless connector system of claim 1, wherein the primary data transceiver has a primary antenna and the secondary data transceiver has a secondary antenna, the primary antenna forming a bi-directional radio link with the secondary antenna.

10. The contactless connector system of claim 9, wherein the primary antenna and the secondary antenna are each circularly polarized antennas.

11. The contactless connector system of claim 1, wherein the secondary sensing unit detects a temperature of the power receiving connector and the temperature is transmitted to the primary control unit via the bi-directional data link.

12. The contactless connector system of claim 1, wherein the power receiving connector has a secondary auxiliary winding inductively coupled to the primary inductive coupler.

13. The contactless connector system of claim 12, wherein the power transmitting connector has a primary auxiliary winding connected to a high-frequency source.

14. The contactless connector system of claim 13, wherein the secondary auxiliary winding is connected to a secondary resonant circuit.

15. A method of inductively transmitting power within a contactless connector system, comprising:
generating a magnetic field at a primary inductive coupler of a power transmitting connector by transforming an input power using a resonant circuit of the power transmitting connector;
receiving electric power at a secondary inductive coupler of a power receiving connector electromagnetically coupled to the primary inductive coupler;
establishing a bi-directional data link between the power transmitting connector and the power receiving connector;
measuring at least one secondary operational parameter using a secondary sensing unit of the power receiving connector; and
controlling operation of the resonant circuit based on the at least one secondary operational parameter and at least one primary operational parameter.

16. The method of claim 15, wherein the at least one primary operational parameter is a primary voltage across the primary inductive coupler, the at least one secondary operational parameter is a secondary voltage across the secondary inductive coupler, and the primary control unit determines a distance between the primary inductive coupler and the secondary inductive coupler based on the primary voltage and the secondary voltage.

17. The method of claim 15, wherein the at least one primary operational parameter is a primary current in the primary inductive coupler, the at least one secondary operational parameter is a secondary voltage across the secondary inductive coupler, and the primary control unit determines a distance between the primary inductive coupler and the secondary inductive coupler based on the primary current and the secondary voltage.

18. The method of claim 16, further comprising disconnecting a load while measuring the secondary voltage.

19. The method of claim 15, wherein the at least one primary operational parameter is a primary current in the primary inductive coupler, an auxiliary current in a primary auxiliary winding, or an auxiliary voltage across the primary auxiliary winding, the at least one secondary operational parameter is a secondary auxiliary voltage across a secondary auxiliary winding inductively coupled to the primary inductive coupler, and the primary control unit determines a distance between the primary inductive coupler and the secondary inductive coupler based on the at least one primary operational parameter and the at least one secondary operational parameter.

20. The method of claim 15, further comprising merging a control signal generated by the secondary sensing unit with a data output transmitted via the bi-directional data link.
